(19) United States
(12) Patent Application Publication
(10) Pub. No.: US 2010/0151155 A1
(43) Pub. Date: Jun. 17, 2010

(54) Liquid Crystal Alignment Agent and Liquid Crystal Alignment Film Manufactured Using the Same

(75) Inventors: Tae-Hyoung KWAK, Goyang-city (KR); Jae-Min OH, Suwon-city (KR); Won-Seok DONG, Seongnam-city (KR); Sun-Nyo YU, Anyang-city (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/712,417

(22) Filed: Feb. 25, 2010

Related U.S. Application Data
(63) Continuation-in-part of application No. PCT/KR2007/007035, filed on Dec. 31, 2007.

(30) Foreign Application Priority Data
Aug. 30, 2007 (KR) 10-2007-0087743

(51) Int. Cl. C09K 19/52

(52) U.S. Cl. 428/1.26; 252/299.4

(57) ABSTRACT

The liquid crystal alignment agent according to one embodiment of the present invention includes a soluble polyimide polymer of Formula 1 and a solvent. The soluble polyimide polymer has a number average molecular weight of about 10,000 to 500,000 g/mol, and a polydispersity of about 1.2 to about 1.75. The liquid crystal alignment agent can have good printability on a substrate, and thereby can provide a liquid crystal alignment film that can have excellent film uniformity, even though its predrying temperature is varied.

### CROSS-REFERENCE TO RELATED APPLICATIONS

This application is a continuation-in-part of International Application No. PCT/KR2007/007035, filed Dec. 31, 2007, pending, which designates the U.S., published as WO 2009/028770, and is incorporated herein by reference in its entirety, and claims priority therefrom under 35 USC Section 120. This application also claims priority under 35 USC Section 119 from Korean Patent Application No. 10-2007-0087743 filed in the Korean Intellectual Property Office on Aug. 30, 2007, which is also incorporated herein by reference in its entirety.

### FIELD OF THE INVENTION

The present invention relates to a liquid crystal alignment agent for a liquid crystal display and a liquid crystal alignment film fabricated using the same. More particularly, the present invention relates to a liquid crystal alignment agent that can have good printability without terminal aggregation phenomena and is capable of providing a uniform film.

### BACKGROUND OF THE INVENTION

Generally, a liquid crystal display is fabricated by coating a liquid crystal alignment agent on a glass substrate deposited with a transparent indium tin oxide (ITO) conductive layer and heating the liquid crystal alignment agent to form a liquid crystal alignment film, and then combining two substrates oppositely facing each other and implanting liquid crystals therebetween. Alternatively, a liquid crystal display can be fabricated by dripping liquid crystals on one substrate and combining it with another substrate oppositely facing the one substrate. In particular, 5^{th} generation, or later, liquid crystal displays used in medium- and large-sized product lines are typically produced using the latter method.

The liquid crystal alignment agent is generally prepared by dissolving a polymer resin for forming an alignment film in a solvent. The polymer resin may include polyamic acid prepared by condensation polymerization of aromatic acid dianhydride and aromatic diamine, polyimide prepared by imidization of polyamic acid (i.e., dehydrating and ring-closing polyamic acid), or one prepared by blending polyamic acid and polyimide

Generally, a liquid crystal alignment film is formed by coating a liquid crystal alignment agent prepared by dissolving polyamic acid or polyimide in an organic solvent on a substrate in a flexo printing method, and then predrying and firing it. When printability of the liquid crystal alignment agent is poor, it may exhibit deviations in film thickness, which can negatively influence display characteristics of a liquid crystal display including the film.

In order to solve this problem, Japanese Patent Laid-Open Publication No. 8-208983 discloses a liquid crystal alignment agent prepared by dissolving diethyleneglycoldiethylether in a solvent with excellent dissolvability against polyamic acid or polyimide. In addition, Korean Patent Laid-Open Publication No. 2005-0106423 discloses a liquid crystal alignment agent with excellent printability, which is prepared by using diethyleneglycoldiethylether and dipropyleneglycolmonomethylether as a solvent.

Accordingly, a liquid crystal alignment agent prepared using the solvents has improved printability since it is rapidly spread out on a substrate. Nonetheless, such processes can result in the formation of aggregations at the ends of the substrate after printing, which can result in a failure to form a uniform film.

### SUMMARY OF THE INVENTION

An exemplary embodiment of the present invention provides a liquid crystal alignment agent which can provide good printability, uniform and stable vertical alignment, and excellent liquid alignment. In addition, the vertical alignment characteristics of the liquid crystal alignment agent may not deteriorate and can remain stable regardless of process conditions, even when it is prepared by a one drop filling (ODF) method.

Another embodiment of the present invention provides a liquid crystal alignment film prepared by using the liquid crystal alignment agent which can have excellent film uniformity.

The embodiments of the present invention are not limited to the above technical purposes, and a person of ordinary skill in the art can understand other technical purposes.

According to one embodiment of the present invention, provided is a liquid crystal alignment agent that includes a soluble polyimide polymer of the following Formula 1 and a solvent. The soluble polyimide polymer has a number average molecular weight of about 10,000 to 500,000 g/mol and a polydispersity of about 1.2 to about 1.75.

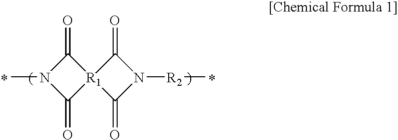

In the above Formula 1,

R₁ is a quadrivalent organic group derived from acid dianhydride selected from the group consisting of aliphatic cyclic acid dianhydrides and aromatic acid dianhydrides, and

R₂ is a divalent organic group derived from aromatic diamine.

Yet another embodiment of the present invention provides a liquid crystal alignment film prepared by coating the liquid crystal alignment agent on a substrate.

Hereinafter, other embodiments of the present invention will be described in detail.

Since the liquid crystal alignment agent can have good printability on a substrate, it can provide a liquid crystal alignment film having excellent film uniformity under various predrying temperatures.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The liquid crystal alignment agent according to one embodiment of the present invention includes a soluble polyimide polymer of the following Formula 1 and a solvent. The soluble polyimide polymer has a number average molecular weight of about 10,000 to 500,000 g/mol and a polydispersity of about 1.2 to about 1.75.

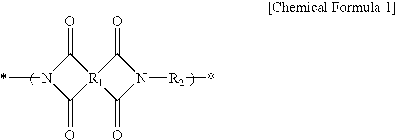

In the above Formula 1,

R₁ is a quadrivalent organic group derived from acid dianhydride selected from the group consisting of aliphatic cyclic acid dianhydrides and aromatic acid dianhydrides, and

R₂ is a divalent organic group derived from an aromatic diamine.

As used herein, when a specific definition is not otherwise provided, the terms alkyl, aryl, heteroaryl, alkylene, cycloalkylene, and heterocycloalkylene refer to C1 to C20 alkyl, C1 to C30 aryl, C2 to C30 heteroaryl, C1 to C16 alkylene, C3 to C30 cycloalkylene, and C2 to C30 heterocycloalkylene, respectively. As also used herein, when a specific definition is not otherwise provided, the terms substituted alkyl, substituted aryl, substituted alkylene, substituted cycloalkylene, and substituted heterocycloalkylene refer to C1 to C20 alkyl, C1 to C30 aryl, C2 to C30 heteroaryl, C1 to C16 alkylene, C3 to C30 cycloalkylene, and C2 to C30 heterocycloalkylene, respectively, substituted with C1 to C30 alkyl, halogen, C1 to C30 haloalkyl, C6 to C30 aryl, C2 to C30 heteroaryl, or C1 to C20 alkoxy.

In the present specification, when a specific definition is not otherwise provided, the terms heterocycloalkyl and heteroaryl refer to cycloalkyl or aryl including 1 to 3 heteroatoms selected from the group consisting of nitrogen (N), oxygen (O), sulfur (S), and phosphorus (P) in one ring and carbon for the rest.

The soluble polyimide polymer can be prepared by synthesizing polyamic acid from aromatic diamine and aliphatic cyclic acid dianhydride or aromatic cyclic acid dianhydride, and then imidizing it.

However, the polyamic acid can be prepared using any common or conventional method known for copolymerization of polyamic acid without any particular limitation.

Examples of the aliphatic cyclic acid dianhydride include 1,2,3,4-cyclobutanetetracarboxylic acid dianhydride (CBDA), 5-(2,5-dioxotetrahydrofuryl)-3-methylcyclohexene-1,2-dicarboxylic acid dianhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarboxyl cyclopentane dianhydride, 1,2,3,4-tetracarboxyl cyclopentane dianhydride, and combinations thereof, but are not limited thereto.

The polyimide polymer may include the aliphatic cyclic acid dianhydride in an amount of about 5 to 90 mol % based on the entire amount of acid dianhydride. In another embodiment, the polyimide polymer may include the aliphatic cyclic acid dianhydride in an amount of about 10 to 50 mol %.

The quadrivalent organic group derived from the aliphatic cyclic acid dianhydride may have a structure selected from the group consisting of compounds represented by the following Formulae 2 to 6 and combinations thereof.

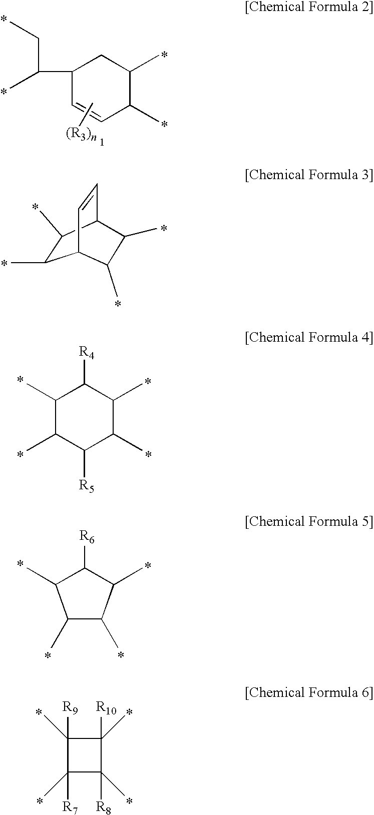

In the above Formulae 2 to 6,

R₃ is selected from the group consisting of substituted or unsubstituted C1 to C20 alkyl, substituted or unsubstituted C1 to C30 aryl, and substituted or unsubstituted C2 to C30 heteroaryl, and n₁ is an integer ranging from 0 to 3, and

R₄ to R₁₀ are independently selected from the group consisting of hydrogen, substituted or unsubstituted C1 to C20 alkyl, substituted or unsubstituted C1 to C30 aryl, and substituted or unsubstituted C2 to C30 heteroaryl.

Examples of the aromatic acid dianhydride include pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and combinations thereof, but are not limited thereto.

The quadrivalent organic group derived from the aromatic acid dianhydride has a structure selected from the group consisting of compounds represented by the following Formulae 7 and 8 and combinations thereof.

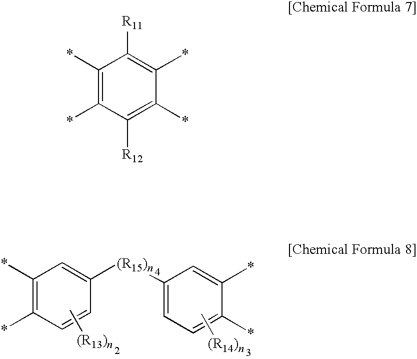

In the above Formulae 7 and 8,

R₁₁ and R₁₂ are independently selected from the group consisting of hydrogen, substituted or unsubstituted C1 to C20 alkyl, substituted or unsubstituted C1 to C30 aryl, and substituted or unsubstituted C2 to C30 heteroaryl,

R₁₃ and R₁₄ are independently selected from the group consisting of substituted or unsubstituted C1 to C20 alkyl, substituted or unsubstituted C1 to C30 aryl, and substituted or unsubstituted C2 to C30 heteroaryl, and n₂ and n₃ are independently integers ranging from 0 to 3, and

R₁₅ is selected from the group consisting of O, CO, C(CF₃)₂, substituted or unsubstituted C1 to C6 alkylene, substituted or unsubstituted C3 to C30 cycloalkylene, and substituted or unsubstituted C2 to C30 heterocycloalkylene, and n₄ is an integer of 0 or 1.

Examples of the aromatic diamine include paraphenylenediamine (p-PDA), 4,4-methylene dianiline (MDA), 4,4-oxydianiline (ODA), metabisaminophenoxy diphenylsulfone (m-BAPS), parabisaminophenoxy diphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, and combinations thereof, but are not limited thereto.

The divalent organic group is derived from the aromatic diamine. The divalent organic group can have a structure selected from the group consisting of compounds represented by the following Formulae 9 to 11 and combinations thereof.

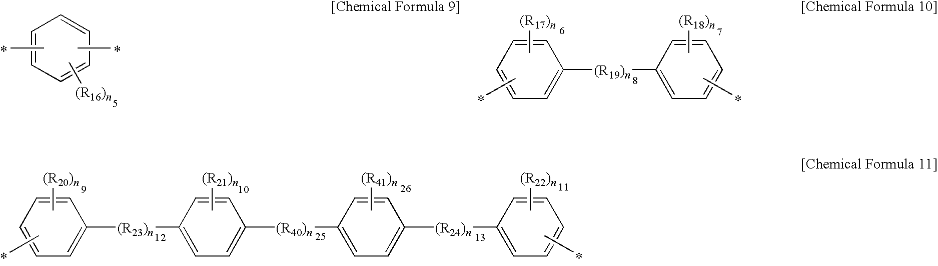

In the above Formulae 9 to 11,

R₁₆ to R₁₈, R₂₀ to R₂₂, and R₄₁ are independently substituents selected from the group consisting of substituted or unsubstituted C1 to C20 alkyl, substituted or unsubstituted C1 to C30 aryl, and substituted or unsubstituted C2 to C30 heteroaryl, wherein the substituent further includes O, COO, CONH, OCO, or a combination thereof,

R₁₉, R₂₃, R₂₄, and R₄₀ are independently selected from the group consisting of O, SO₂, C(CF₃)₂, and C(R₄₂)(R₄₃), wherein R₄₂ and R₄₃ are selected from the group consisting of independently hydrogen, substituted or unsubstituted C1 to C20 alkyl, substituted or unsubstituted C1 to C30 aryl, and substituted or unsubstituted C2 to C30 heteroaryl,

n₅ to n₇, n₉ to n₁₁, and n₂₆ are independently integers ranging from 0 to 4, and

n₈, n₁₂, n₁₃, and n₂₅ are independently integers of 0 or 1.

In addition, the aromatic diamine may include functional diamines selected from the group consisting of compounds represented by the following Formulae 12 to 14 and combinations thereof, so that an alignment film of a liquid crystal can have an easily-controlled pre-tilt angle of a liquid crystal molecule and excellent alignment characteristics.

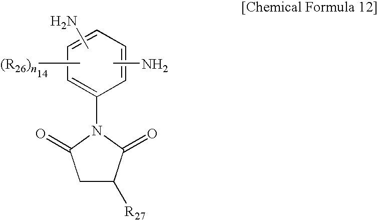

In the above Formula 12,

R₂₆ is selected from the group consisting of substituted or unsubstituted C1 to C20 alkyl, substituted or unsubstituted C1 to C30 aryl, and substituted or unsubstituted C2 to C30 heteroaryl, and n₁₄ is an integer ranging from 0 to 3, and

R₂₇ is selected from the group consisting of hydrogen, substituted or unsubstituted C1 to C20 alkyl, substituted or unsubstituted C1 to C30 aryl, and substituted or unsubstituted C2 to C30 heteroaryl.

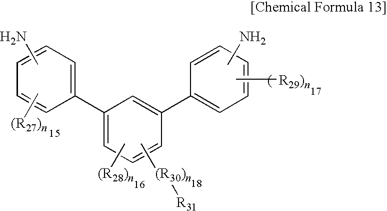

In the above Formula 13,

R₂₇ to R₂₉ are independently selected from the group consisting of substituted or unsubstituted C1 to C20 alkyl, substituted or unsubstituted C1 to C30 aryl, and substituted or unsubstituted C2 to C30 heteroaryl,

R₃₀ is selected from the group consisting of O, COO, CONH, OCO, and (C(R₃₈)(R₃₉))ₙ₂₄, wherein R₃₈ and R₃₉ are independently selected from the group consisting of hydrogen, substituted or unsubstituted C1 to C20 alkyl, substituted or unsubstituted C1 to C30 aryl, and substituted or unsubstituted C2 to C30 heteroaryl, and n₂₄ is an integer ranging from 1 to 10,

R₃₁ is selected from the group consisting of hydrogen, substituted or unsubstituted C1 to C20 alkyl, substituted or unsubstituted C1 to C30 aryl, and substituted or unsubstituted C2 to C30 heteroaryl,

n₁₅ and n₁₇ are independently integers ranging from 0 to 4,

n₁₆ is an integer ranging from 0 to 3, and

n₁₈ is an integer of 0 or 1.

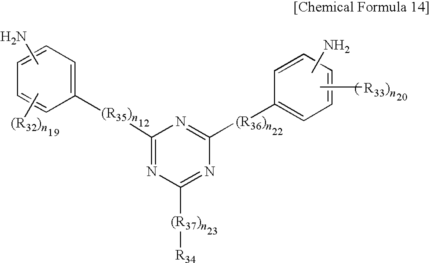

In the above Formula 14,

R₃₂ and R₃₃ are independently selected from the group consisting of substituted or unsubstituted C1 to C20 alkyl, substituted or unsubstituted C1 to C30 aryl, and substituted or unsubstituted C2 to C30 heteroaryl,

R₃₄ is selected from the group consisting of hydrogen, substituted or unsubstituted C1 to C20 alkyl, substituted or unsubstituted C1 to C30 aryl, and substituted or unsubstituted C2 to C30 heteroaryl,

R₃₅ and R₃₆ are independently selected from the group consisting of O and COO,

R₃₇ is selected from the group consisting of O, COO, CONH, and OCO,

n₁₉ and n₂₀ are independently integers ranging from 0 to 4, and

n₂₁ to n₂₃ are independently integers of 0 or 1.

The polyamic acid can be dehydrated and ring-closed, and then imidized to prepare the soluble polyimide polymer.

The aromatic amine and acid anhydride may be used in each amount so that an amine group of the aromatic amine and an acid anhydride group of the acid anhydride may be reacted with each other at a 1:1 equivalent ratio.

The soluble polyimide polymer has a number average molecular weight ranging from about 10,000 to 500,000 g/mol and a polydispersity ranging from about 1.2 to about 1.75. When the soluble polyimide polymer has a polydispersity of about 1.2 or less, a prepared film may have problems of terminal aggregations on a substrate and the like. When it has a polydispersity of about 1.75 or more, a prepared film may not be smooth and have thickness deviation at the ends of a substrate.

The soluble polyimide polymer may have a polydispersity variously regulated by the aromatic diamine, the functional diamine, and the acid dianhydride added in a particular order. When the aromatic diamine is first mixed with the functional diamine and then reacted with the acid dianhydride according to a conventional method, the soluble polyimide polymer can have a polydispersity within the above range.

In other words, when the aromatic diamine is reacted with the acid dianhydride, and then with the functional diamine, or the functional diamine is reacted with the acid dianhydride, and then with the aromatic diamine, the soluble polyimide polymer may not have a polydispersity within the above range. However, the soluble polyimide polymer have a polydispersity within the above range using other various ways or techniques.

The liquid crystal alignment agent may include the soluble polyimide polymer and a solvent that can dissolve the soluble polyimide polymer.

The solvent may include N-methyl-2-pyrrolidone, N,N-dimethyl acetamide, N,N-dimethyl formamide, dimethyl sulfoxide, γ-butyro lactone, and a phenol-based solvent such as meta cresol, phenol, halgenated phenol, and the like.

In addition, the solvent may further include a poor solvent such as alcohol series, ketone series, ester series, ether series, hydrocarbon series, or halgenated hydrocarbon series, so long as the soluble polyimide polymer is not precipitated. The poor solvent can lower the surface energy of a liquid crystal alignment agent and can improve its spread and flatness, when coating the liquid crystal alignment agent on a substrate.

The poor solvent may be included in an amount of 1 to 90 volume % based on the entire amount of solvent. In another embodiment, it may be included in an amount of 1 to 70 volume %.

Specific examples of the poor solvent include methanol, ethanol, isopropanol, cyclohexanol, ethylene glycol, propylene glycol, 1,4-butanediol, triethylene glycol, acetone, methylethylketone, cyclohexanone, methyl acetate, ethyl acetate, butyl acetate, diethyl hydroxide, malonic acid ester, diethyl ether, ethylene glycol monomethyl ether, ethylene glycol monoethyl ether, ethylene glycol phenyl ether, ethylene glycol phenyl methyl ether, ethylene glycol phenyl ethyl ether, ethylene glycol dimethylethyl, diethylene glycol dimethylethyl, diethyleneglycol ether, diethyleneglycol monomethyl ether, diethylene glycol monoethyl ether, diethylene glycol monomethyl ether acetate, diethylene glycol monoethyl ether acetate, ethylene glycol methyl ether acetate, ethylene glycol ethyl ether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, 2-hydroxy-3-methyl butanoic acid methyl, 3-methoxy methyl propionate, 3-methoxy ethyl propionate, 3-ethoxy ethyl propionate, 3-ethoxy methyl propionate, methyl methoxy butanol, ethyl methoxy butanol, methyl ethoxy butanol, ethyl ethoxy butanol, tetrahydrofuran, dichloromethane, 1,2-dichloroethane, 1,4-dichloro butane, tri chloro ethane, chlorobenzene, o-dichlorobenzene, hexane, heptane, octane, benzene, toluene, xylene, and combinations thereof.

There is no particular limit on the amount of solvent included in the liquid crystal alignment agent and the solvent may be appropriately included in any amount, so long as the alignment agent of a liquid crystal solid is included in an amount of about 0.01 to 30 wt %, about 3 to 15 wt %, or about 5 to 10 wt % in another embodiment. When the solid is included in an amount of about 0.01 wt % or less, a prepared film may be influenced by a substrate surface, and thereby can have deteriorated uniformity. When the solid is included in an amount of about 30 wt %, a film may have deteriorated uniformity due to high viscosity, and thereby deteriorated transmittance.

Accordingly, the liquid crystal alignment agent may have an extensional viscosity ranging from about 1.5 to 2.2 Pa·s. When it has an extensional viscosity of about 1.5 Pa·s or less, a substrate may have a stain at the ends. When the liquid crystal alignment agent has extensional viscosity of about 2.2 Pa·s or more, a film may be non-uniform due to thickness deviation at the ends.

The liquid crystal alignment agent may include an epoxy compound having 2 to 4 epoxy functional groups to improve reliability and electro-optic characteristics. The epoxy compound may be included in an amount of about 0.01 to 50 parts by weight based on 100 parts by weight of the soluble polyimide polymer. In another embodiment, the epoxy compound may be included in an amount of about 1 to 30 parts by weight. When the epoxy compound is included in an amount of about 50 parts by weight or more, it may deteriorate printability or flatness. When the epoxy compound is included in an amount of about 1 part by weight or less, it may have little effect.

Specific examples of the epoxy compound may include N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, and the like, but are not limited thereto.

In addition, the liquid crystal alignment agent can further include a silane coupling agent or surfactant to improve adherence to a substrate and flatness and coating characteristics.

The liquid crystal alignment agent is coated to form a liquid crystal alignment film. The liquid crystal alignment agent can be coated by a method such as spin coating, flexo printing, inkjet printing, and the like. The flexo printing can accomplish excellent uniformity of a film and easily form a bigger film.

The substrate is not particularly limited and may include a glass substrate or a plastic substrate such as an acrylic substrate or a polycarbonate substrate, as long as it is transparent. In addition, the substrate may include a substrate including an ITO electrode and the like for liquid crystal operation to simplify the manufacturing process.

In order to improve uniformity of a film, the liquid crystal alignment agent may be uniformly coated on a substrate and predried at room temperature to 200° C., 30 to 150° C., or 40 to 120° C. for 1 to 100 minutes. The predrying can control volatility of each component of the liquid crystal alignment agent, securing a uniform film without thickness deviation.

Then, the coated substrate is fired at a temperature of 80 to 300° C. or 120 to 280° C. for 5 to 300 minutes to completely evaporate the solvent, preparing a liquid crystal alignment film.

The liquid crystal alignment film can be used for a liquid crystal display with uniaxial alignment treatment by polarized ultraviolet (UV) or rubbing, or without the uniaxial alignment treatment for some uses such as a vertical alignment layer and the like. Since the liquid crystal alignment film can have high uniformity, a liquid crystal display can be fabricated in a good yield, even when a large substrate is used.

Hereinafter, a method of preparing a liquid crystal alignment agent of the present invention, and also of preparing a liquid crystal alignment film by using the liquid crystal alignment agent is illustrated with reference to Examples and Comparative Examples. The embodiments of the present invention are not limited to the above technical purposes, and a person of ordinary skill in the art can understand other technical purposes.

### Preparation of Liquid Crystal Alignment Agents

### Example 1

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved.

Next, 0.5 mol of 3,5-diaminophenyldecylsuccinimide represented by the following Formula 15 is added to the solution, and N-methyl-2-pyrrolidone (NMP) is dissolved in the resulting solution. Then, the resulting solution is intensely agitated. Herein, the solid powder is included in an amount of 15 wt %. The solution is reacted at a temperature of 30 to 50° C. for 10 hours, preparing a polyamic acid solution.

Then, 3.0 mol of acetic acid anhydride and 5.0 mol of pyridine are added to the polyamic acid solution. The resulting product is heated up to 80° C. and reacted for 6 hours, and then vacuum-distillated, preparing a soluble polyimide resin including 30 wt % of the solid.

Then, N-methyl-2-pyrrolidone (NMP) is added to the soluble polyimide resin and agitated at room temperature for 24 hours, preparing a liquid crystal alignment agent.

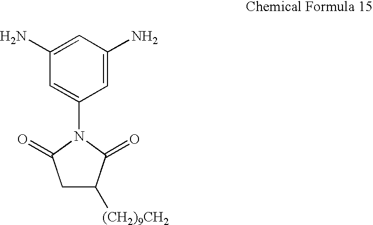

### Example 2

0.5 mol of 3,5-diaminophenyldecylsucciimide represented by the above Formula 15 is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved.

Next, 0.5 mol of phenylenediamine is added to the solution, and N-methyl-2-pyrrolidone (NMP) is also dissolved therein. Then, the resulting product is intensely agitated. Herein, the solid powder is included in an amount of 15 wt %. The final resulting product is reacted at a temperature of 30 to 50° C. for 10 hours, preparing a polyamic acid solution.

The polyamic acid solution is treated according to the same method as Example 1 to prepare a liquid crystal alignment agent.

### Example 3

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride in a solid state is added thereto and completely dissolved.

Next, 0.5 mol of 3,5-bis(3-aminophenyl)-methylphenoxytri fluoropentadecane represented by the following Formula 16 is added to the solution. Then, N-methyl-2-pyrrolidone (NMP) is added thereto for dissolution and intensely agitated. Herein, the solid powder is added in an amount of 15 wt %. The resulting product is agitated for 10 hours at a temperature of 30 to 50° C. to prepare a polyamic acid solution.

The polyamic acid solution is treated according to the same method as Example 1 to prepare a liquid crystal alignment agent.

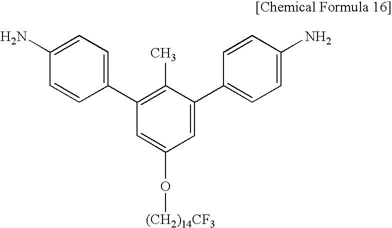

### Example 4

0.5 mol of 3,5-bis(3-aminophenyl)-methylphenoxytri fluoropentadecane represented by the above Formula 16 is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved.

Next, 0.5 mol of phenylenediamine is added to the completely dissolved solution, and N-methyl-2-pyrrolidone (NMP) is dissolved therein. The resulting product is intensely agitated. Herein, the solid powder is included in an amount of 15 wt %. The final resulting product is reacted at a temperature of 30 to 50° C. for 10 hours to prepare a polyamic acid solution.

The polyamic acid solution is treated according to the same method as Example 1, to prepare a liquid crystal alignment agent.

### Example 5

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved.

Next, 0.5 mol of 2,4-dinitrophenoxy-6-hexadecyl-1,3,5-triazine represented by the following Formula 17 is added thereto, and then N-methyl-2-pyrrolidone (NMP) is dissolved therein. The resulting product is intensely agitated. Herein, the solid powder is included in an amount of 15 wt %. The final resulting product is reacted for 10 hours at a temperature of 30 to 50° C., preparing a polyamic acid solution.

The polyamic acid solution is treated according to the same method as Example 1, to prepare a liquid crystal alignment agent.

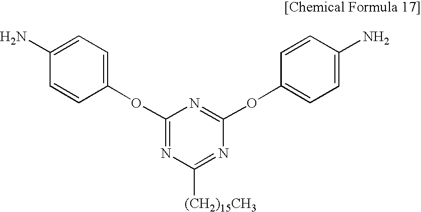

### Example 6

0.5 mol of 2,4-dinitrophenoxy-6-hexadecyl-1,3,5-triazine represented by the above Formula 17 is completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved.

Then, 0.5 mol of phenylenediamine is added thereto, and then N-methyl-2-pyrrolidone (NMP) is dissolved therein. The resulting solution is intensely agitated. Herein, the solid powder is included in an amount of 15 wt %. The final resulting product is reacted for 10 hours at a temperature of 30 to 50° C., preparing a polyamic acid solution.

The polyamic acid solution is treated according to the same method as Example 1, to prepare a liquid crystal alignment agent.

### Example 7

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of 3,5-diaminophenyldecylsucciimide represented by the above Formula 15 and N-methyl-2-pyrrolidone (NMP) are respectively added to the solution and intensely agitated. Herein, the solid powder is included in an amount of 15 wt %. The resulting product is reacted for 10 hours at a temperature of 30 to 50° C., preparing a polyamic acid solution.

The polyamic acid solution is treated according to the same method as Example 1, to prepare a liquid crystal alignment agent.

### Example 8

0.5 mol of 3,5-diaminophenyldecylsucciimide represented by the above Formula 15 is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of phenylenediamine is added to the solution, and N-methyl-2-pyrrolidone (NMP) is dissolved therein. The resulting solution is intensely agitated. Herein, the solid powder is included in an amount of 15 wt %. The final resulting product is reacted for 10 hours at a temperature of 30 to 50° C., preparing a polyamic acid solution.

The polyamic acid solution is treated according to the same method as Example 1, to prepare a liquid crystal alignment agent.

### Example 9

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of 3,5-bis(3-aminophenyl)-methylphenoxytri fluoropentadecane represented by the above Formula 16 and N-methyl-2-pyrrolidone (NMP) are respectively added to the solution and intensely agitated. Herein, the solid powder is included in an amount of 15 wt %. The resulting product is reacted for 10 hours at a temperature of 30 to 50° C., preparing a polyamic acid solution.

The polyamic acid solution is treated according to the same method as Example 1, to prepare a liquid crystal alignment agent.

### Example 10

0.5 mol of 3,5-bis(3-aminophenyl)-methylphenoxytri fluoropentadecane represented by the above Formula 16 is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of phenylenediamine and N-methyl-2-pyrrolidone (NMP) are respectively added to the solution and intensely agitated. Herein, the solid powder is included in an amount of 15 wt %. The resulting product is reacted for 10 hours at a temperature of 30 to 50° C., preparing a polyamic acid solution.

The polyamic acid solution is treated according to the same method as Example 1, to prepare a liquid crystal alignment agent.

### Example 11

0.5 mol of phenylenediamine is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of 2,4-dinitrophenoxy-6-hexadecyl-1,3,5-triazine represented by the above Formula 17 and N-methyl-2-pyrrolidone (NMP) are respectively added to the solution and intensely agitated. Herein, the solid is included in an amount of 15 wt %. The resulting product is reacted for 10 hours at a temperature of 30 to 50° C., preparing a polyamic acid solution.

The polyamic acid solution is treated according to the same method as Example 1, to prepare a liquid crystal alignment agent.

### Example 12

0.5 mol of 2,4-dinitrophenoxy-6-hexadecyl-1,3,5-triazine represented by the above Formula 17 is completely dissolved in N-methyl-2-pyrrolidone (NMP), while passing nitrogen through a 4-neck flask with an agitator, a temperature controller, a nitrogen injector, and a cooler. Then, 1.0 mol of 5-(2,5-dioxotetrahydrofuryl)-3-methylcyclohexane-1,2-dicarboxylic acid dianhydride (DOCDA) is added thereto and completely dissolved.

Then, 0.5 mol of phenylenediamine and N-methyl-2-pyrrolidone (NMP) are respectively added to the solution and intensely agitated. Herein, the solid powder is included in an amount of 15 wt %. The resulting product is reacted for 10 hours at a temperature of 30 to 50° C., preparing a polyamic acid solution.

The polyamic acid solution is treated according to the same method as Example 1, to prepare a liquid crystal alignment agent.

### Comparative Example 1

0.5 mol of phenylenediamine and 0.5 mol of 3,5-diaminophenyldecylsucciimide represented by the above Formula 15 are completely dissolved in N-methyl-2-pyrrolidone (NMP), while passing nitrogen through a 4-neck flask with an agitator, a temperature controller, a nitrogen injector, and a cooler. Then, 1.0 mol of 1,2,3,4-cyclobutanetetracarboxylic acid dianhydride is added thereto and completely dissolved. Herein, the solid powder is included in an amount of 15 wt %. The resulting product is reacted for 10 hours at a temperature of 30 to 50° C., preparing a polyamic acid solution.

Next, 3.0 mol of acetic acid anhydride and 5.0 mol of pyridine are added to the polyamic acid solution. The resulting mixture is heated up to 80° C. and reacted for 6 hours. Then, it is vacuum-distilled, to prepare a soluble polyimide resin including 30 wt % of the solid powder.

Then, N-methyl-2-pyrrolidone (NMP) is added to the soluble polyimide resin. The resulting product is agitated at room temperature for 24 hours, to prepare a liquid crystal alignment agent.

### Comparative Example 2

A liquid crystal alignment agent is prepared according to the same method as Comparative Example 1 except for using 0.5 mol of diamine 3,5-bis(3-aminophenyl)-methylphenoxytri fluoropentadecane represented by the above Formula 16.

### Comparative Example 3

A liquid crystal alignment agent is prepared according to the same method as Comparative Example 1 except for using 0.5 mol of diamine 2,4-dinitrophenoxy-6-hexadecyl-1,3,5-triazine represented by the above Formula 17.

### Comparative Example 4

A liquid crystal alignment agent is prepared according to the same method as Comparative Example 1 except for using 1.0 mol of 5-(2,5-dioxotetrahydrofuryl)-3-methylcyclohexane-1,2-dicarboxylic acid dianhydride (DOCDA) as an acid dianhydride.

### Comparative Example 5

A liquid crystal alignment agent is prepared according to the same method as Comparative Example 1 except for using 0.5 mol of diamine 3,5-bis(3-aminophenyl)-methylphenoxytri fluoropentadecane represented by the above Formula 16 and 1.0 mol of 5-(2,5-dioxotetrahydrofuryl)-3-methylcyclohexane-1,2-dicarboxylic acid dianhydride (DOCDA) as acid dianhydride.

### Comparative Example 6

A liquid crystal alignment agent is prepared according to the same method as Comparative Example 1 except for using 0.5 mol of diamine 2,4-dinitrophenoxy-6-hexadecyl-1,3,5-triazine represented by the above Formula 17 and 1.0 mol of 5-(2,5-dioxotetrahydrofuryl)-3-methylcyclohexane-1,2-dicarboxylic acid dianhydride (DOCDA) as acid dianhydride.

Measurement of Polydispersity of Soluble Polyimide Polymers

The liquid crystal alignment agents according to Examples 1 to 12 and Comparative Examples 1 to 6 are measured regarding number average molecular weight and polydispersity by using a gel permission chromatography (GPC, CTS30®, Younglin Instrument Co., Ltd.). The results are shown in Table 1.

Measurement of Extensional Viscosity of Liquid Crystal Alignment Agents

The liquid crystal alignment agents according to Examples 1 to 12 and Comparative Examples 1 to 6 are measured regarding extensional viscosity and time till liquid filaments broke (t_{break}) by using a capillary breakup extensional rheometer (CaBER®, TA instruments). The results are shown in Table 1.

Evaluation of Uniformity of Ending Film Strips

The liquid crystal alignment agents of Examples 1 to 12 and Comparative Examples 1 to 6 are respectively flexo-printed on a glass substrate including cleaned ITO by using an alignment layer printer (CZ 200®, Nakan Co.). The printed substrate is allowed to stand on a hot plate at a temperature of 50 to 90° C. for 2 to 5 minutes for predrying.

Then, it is fired on a hot plate at a temperature of 200 to 230° C. for 10 to 30 minutes, preparing a substrate coated with an alignment film of a liquid crystal thereon.

The liquid crystal alignment film is measured regarding thickness change over the entire surface (middle and end parts) with the naked eye and also with an electron microscope (MX50®, Olympus Co.). The results are shown in Table 1.

Referring to the following Table 1, when the liquid crystal alignment film has a film thickness deviation of less than about 0.005 μm, this is indicated as “good”. When the liquid crystal alignment film has a film thickness deviation ranging from about 0.005 to 0.01 μm, this is indicated as “average”, and when the liquid crystal alignment film has a film thickness deviation of more than about 0.01 μm, this is indicated as “bad”.

TABLE 1

| | | number | | | |
|---|---|---|---|---|---|
| | | average | ex- | | |
| | | molecular | tensional | | |
| | poly- | weight | viscosity | t_{break} | end film |
| | dispersity | (10,000 g/mol) | (Pa · s) | (s) | uniformity |
| Example 1 | 1.56 | 14.3 | 1.89 | 0.20 | good |
| Example 2 | 1.53 | 14.8 | 1.73 | 0.21 | good |
| Example 3 | 1.54 | 14.6 | 1.79 | 0.18 | good |
| Example 4 | 1.53 | 14.6 | 1.95 | 0.20 | good |
| Example 5 | 1.55 | 14.1 | 1.98 | 0.21 | good |
| Example 6 | 1.53 | 13.9 | 1.81 | 0.21 | good |
| Example 7 | 1.54 | 14.2 | 1.76 | 0.19 | good |
| Example 8 | 1.52 | 14.3 | 1.92 | 0.21 | good |
| Example 9 | 1.55 | 14.3 | 1.88 | 0.20 | good |
| Example 10 | 1.53 | 14.5 | 1.92 | 0.18 | good |
| Example 11 | 1.51 | 14.5 | 1.88 | 0.19 | good |
| Example 12 | 1.51 | 14.6 | 1.86 | 0.21 | good |
| Comparative | 1.81 | 14.1 | 2.33 | 0.26 | bad |
| Example 1 | | | | | |
| Comparative | 1.84 | 14.8 | 2.41 | 0.26 | bad |
| Example 2 | | | | | |
| Comparative | 1.84 | 13.9 | 2.30 | 0.25 | bad |
| Example 3 | | | | | |
| Comparative | 1.85 | 15.0 | 2.35 | 0.25 | bad |
| Example 4 | | | | | |
| Comparative | 1.83 | 14.5 | 2.42 | 0.26 | bad |
| Example 5 | | | | | |
| Comparative | 1.84 | 14.4 | 2.32 | 0.26 | bad |
| Example 6 | | | | | |

Referring to Table 1, the liquid crystal alignment agents of Examples 1 to 12 have a polydispersity ranging from about 1.2 to about 1.75 and relatively small extensional viscosity and t_{break}. On the contrary, the liquid crystal alignment agents of Comparative Examples 1 to 6 have a polydispersity of 1.75 or more and relatively large extensional viscosity and t_{break}.

In addition, the liquid crystal alignment films including the liquid crystal alignment agents of Examples 1 to 12 have smaller extensional viscosity and t_{break} than the ones including the liquid crystal alignment agents of Comparative Examples 1 to 6. Accordingly, the liquid crystal alignment films including the liquid crystal alignment agents of Examples 1 to 12 exhibit no terminal aggregation phenomenon. Furthermore, the liquid crystal alignment films including the liquid crystal alignment agent of Examples 1 to 12 have excellent printability and uniformity.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An liquid crystal alignment agent comprising:
a soluble polyimide polymer of the following Formula 1 and a solvent,
wherein the soluble polyimide polymer has a number average molecular weight of about 10,000 to 500,000 g/mol, and a polydispersity of about 1.2 to about 1.75, 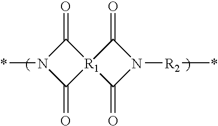
wherein, in the above Formula 1,
R₁ is a quadrivalent organic group derived from acid dianhydride selected from the group consisting of aliphatic cyclic acid dianhydrides and aromatic acid dianhydrides, and
R₂ is a divalent organic group derived from an aromatic diamine.

2. The liquid crystal alignment agent of claim 1, wherein the liquid crystal alignment agent has an extensional viscosity of about 1.5 to 2.2 Pa·s.

3. The liquid crystal alignment agent of claim 1, wherein the liquid crystal alignment agent includes a solid content of about 0.01 to 30 wt % based on the total weight of the liquid crystal alignment agent.

4. The liquid crystal alignment agent of claim 1, wherein the aliphatic cyclic acid dianhydride is selected from the group consisting of 1,2,3,4-cyclobutanetetracarboxylic acid dianhydride (CBDA), 5-(2,5-dioxotetrahydrofuryl)-3-methylcyclohexene-1,2-dicarboxylic acid dianhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarboxyl cyclopentane dianhydride, 1,2,3,4-tetracarboxyl cyclopentane dianhydride, and combinations thereof.

5. The liquid crystal alignment agent of claim 1, wherein R₁ is a quadrivalent organic group selected from the group consisting of compounds represented by the following Formulae 2 to 6, and combinations thereof, 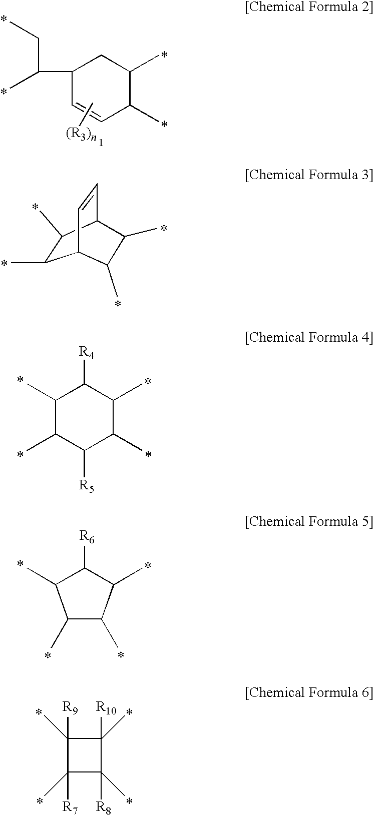
wherein, in the above Formulae 2 to 6,
R₃ is selected from the group consisting of substituted or unsubstituted C1 to C20 alkyl, substituted or unsubstituted C1 to C30 aryl, and substituted or unsubstituted C2 to C30 heteroaryl, and n₁ is an integer ranging from 0 to 3, and
R₄ to R₁₀ are independently selected from the group consisting of hydrogen, substituted or unsubstituted C1 to C20 alkyl, substituted or unsubstituted C1 to C30 aryl, and substituted or unsubstituted C2 to C30 heteroaryl.

6. The liquid crystal alignment agent of claim 1, wherein the aromatic acid dianhydride is selected from the group consisting of pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and combinations thereof.

7. The liquid crystal alignment agent of claim 1, wherein R₁ is a quadrivalent organic group selected from the group consisting of compounds represented by the following Formulae 7 and 8, and combinations thereof, 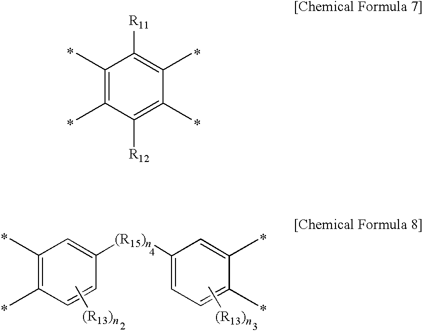
wherein, in the above Formulae 7 and 8,
R₁₁ and R₁₂ are independently selected from the group consisting of hydrogen, substituted or unsubstituted C1 to C20 alkyl, substituted or unsubstituted C1 to C30 aryl, and substituted or unsubstituted C2 to C30 heteroaryl,
R₁₃ and R₁₄ are independently selected from the group consisting of substituted or unsubstituted C1 to C20 alkyl, substituted or unsubstituted C1 to C30 aryl, and substituted or unsubstituted C2 to C30 heteroaryl, and n₂ and n₃ are independently integers ranging from 0 to 3, and
R₁₅ is selected from the group consisting of O, CO, C CF₃₂, substituted or unsubstituted C1 to C16 alkylene, substituted or unsubstituted C3 to C30 cycloalkylene, and substituted or unsubstituted C2 to C30 heterocycloalkylene, and n₄ is an integer of 0 or 1.

8. The liquid crystal alignment agent of claim 1, wherein the aromatic diamine is selected from the group consisting of paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene and combinations thereof.

9. The liquid crystal alignment agent of claim 1, wherein R₂ is a divalent organic group selected from the group consisting of compounds of the following Formulae 9 to 11, and combinations thereof, 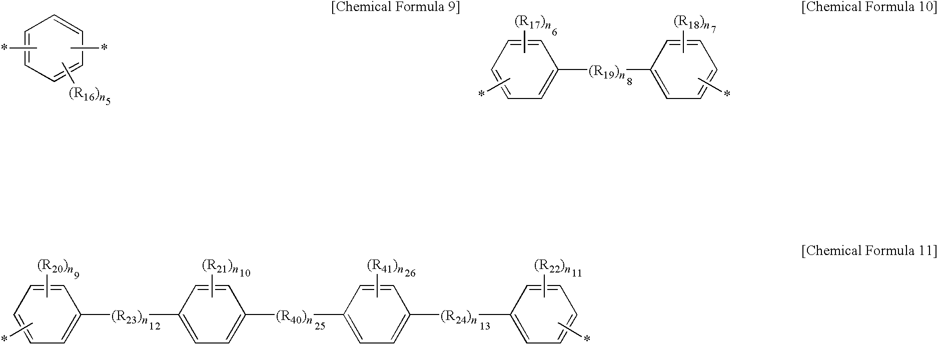
wherein, in the above Formulae 9 to 11,
R₁₆ to R₁₈, R₂₀ to R₂₂, and R₄₁ are substituents independently selected from the group consisting of substituted or unsubstituted C1 to C20 alkyl, substituted or unsubstituted C1 to C30 aryl, and substituted or unsubstituted C2 to C30 heteroaryl, wherein the substituent further includes O, COO, CONH, OCO, or a combination thereof,
R₁₉, R₂₃, R₂₄, and R₄₀ are independently selected from the group consisting of O, SO₂, C(CF₃)₂, and C(R₄₂)(R₄₃), wherein R₄₂ and R₄₃ are independently selected from the group consisting of hydrogen, substituted or unsubstituted C1 to C20 alkyl, substituted or unsubstituted C1 to C30 aryl, and substituted or unsubstituted C2 to C30 heteroaryl,
n₅ to n₇, n₉ to n₁₁, and n₂₆ are independently integers ranging from 0 to 4, and
n₈, n₁₂, n₁₃ and n₂₅ are independently integers of 0 or 1.

10. The liquid crystal alignment agent of claim 1, wherein the aromatic diamine is selected from the group consisting of compounds of the following Formulae 12 to 14, and combinations thereof, 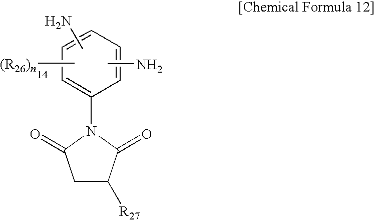
wherein, in the above Formula 12,
R₂₆ is selected from the group consisting of substituted or unsubstituted C1 to C20 alkyl, substituted or unsubstituted C1 to C30 aryl, and substituted or unsubstituted C2 to C30 heteroaryl, and n₁₄ is an integer ranging from 0 to 3, and
R₂₇ is selected from the group consisting of hydrogen, substituted or unsubstituted C1 to C20 alkyl, substituted or unsubstituted C1 to C30 aryl, and substituted or unsubstituted C2 to C30 heteroaryl, 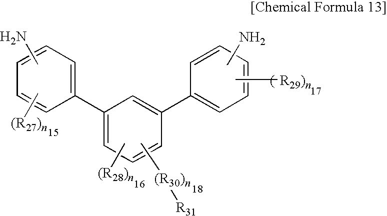
wherein, in the above Formula 13,
R₂₇ to R₂₉ are independently selected from the group consisting of substituted or unsubstituted C1 to C20 alkyl, substituted or unsubstituted C1 to C30 aryl, and substituted or unsubstituted C2 to C30 heteroaryl,
R₃₀ is selected from the group consisting of O, COO, CONH, OCO, and (C(R₃₈)(R₃₆))ₙ₂₄, wherein R₃₈ and R₃₉ are independently selected from the group consisting of hydrogen, substituted or unsubstituted C1 to C20 alkyl, substituted or unsubstituted C1 to C30 aryl, and substituted or unsubstituted C2 to C30 heteroaryl, and n₂₄ is an integer ranging from 1 to 10,
R₃₁ is selected from the group consisting of hydrogen, substituted or unsubstituted C1 to C20 alkyl, substituted or unsubstituted C1 to C30 aryl, and substituted or unsubstituted C2 to C30 heteroaryl,
n₁₅ and n₁₇ are independently integers ranging from 0 to 4,
n₁₆ is an integer ranging from 0 to 3, and
n₁₈ is an integer of 0 or 1, 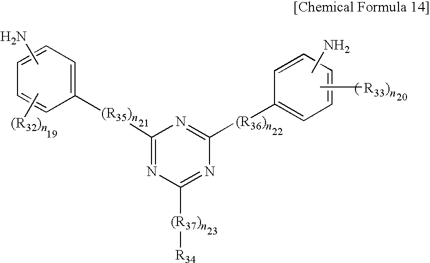
wherein, in the above Formula 14,
R₃₂ and R₃₃ are independently selected from the group consisting of substituted or unsubstituted C1 to C20 alkyl, substituted or unsubstituted C1 to C30 aryl, and substituted or unsubstituted C2 to C30 heteroaryl,
R₃₄ is selected from the group consisting of hydrogen, substituted or unsubstituted C1 to C20 alkyl, substituted or unsubstituted C1 to C30 aryl, and substituted or unsubstituted C2 to C30 heteroaryl,
R₃₅ and R₃₆ are independently selected from the group consisting of O and COO,
R₃₇ is selected from the group consisting of O, COO, CONH, and OCO,
n₁₉ and n₂₀ are independently integers ranging from 0 to 4, and
n₂₁ to n₂₃ are independently integers of 0 or 1.

11. The liquid crystal alignment agent of claim 1, further comprising an epoxy compound having 2 to 4 epoxy functional groups in an amount of 1 to 50 parts by weight based on 100 parts by weight of the soluble polyimide polymer.

12. An liquid crystal alignment film fabricated by applying the liquid crystal alignment agent according to claim 1 on a substrate.
